(19) United States
(12) Patent Application Publication
(10) Pub. No.: US 2026/0260179 A1
(43) Pub. Date: Sep. 3, 2026

(54) Sugarcane Smart Planting Visualization

(71) Applicant: Deere & Company, Moline, IL (US)

(72) Inventors: Mahesh Satish Bothe, Pune (IN); Sagar V. Jadhav, Pune (IN); Joseph James Akers, Denver, IA (US); Jess Joseph Castagnos, Gonzales, LA (US)

(21) Appl. No.: 19/176,098

(22) Filed: Apr. 10, 2025

Related U.S. Application Data
(60) Provisional application No. 63/766,215, filed on Mar. 3, 2025.

(51) Int. Cl. G06Q 10/04; A01G 22/55; G06Q 50/02; G06T 7/11; G06V 10/764; G06V 20/10; G06V 20/56

(52) U.S. Cl. CPC G06Q 10/04; A01G 22/55; G06Q 50/02; G06T 7/11; G06V 10/764; G06V 20/188; G06V 20/56; G06T 2207/30188

(57) ABSTRACT

A method for predicting a yield of a sugarcane planting machine is disclosed. The disclosed method accesses a target planting ratio quantifying a target ratio of billets to soil in a furrow over a distance. The disclosed method accesses image data representing the furrow in the field, and the image data comprises pixels representing billets and soil in the furrow. The disclosed method applies a machine-learned model to the accessed image data to classify the image data as billets or soil, and to calculate the current planting ratio quantifying a current ratio of billets to soil in the furrow over the distance. The disclosed method generates a visualization of the current planting ratio and the target planting ratio to display on the sugarcane planting machine.

### CROSS-REFERENCE TO RELATED APPLICATIONS

This application claims the benefit of U.S. Provisional Application No. 63/766,215, filed on Mar. 3, 2025, which is hereby incorporated by reference in its entirety.

### TECHNICAL FIELD

This disclosure relates generally to adjusting billet planting operations of a farming machine, and, more specifically, to providing predictions that assist agricultural managers to increase the yield of the farming machine.

### BACKGROUND

Sugarcane is primarily planted using vegetative planting methods, where sections of the stalk, known as billets, are planted to generate new plants. Proper billet placement is important for increasing crop yield-where appropriately alignment and spacing increase yield, while inappropriate alignment and spacing decrease yield.

Currently, two primary methods are used for sugarcane planting to properly place billets: manual (hand) planting and mechanical planting. Manual planting refers to farmers individually placing sugarcane billets into pre-formed furrows within a field. This process requires significant labor, as each billet must be carefully positioned to maximize sugarcane yield. Manual planting methods restrict the scalability of sugarcane farming due to their labor-intensive nature, high costs, and time-consuming process, making it an expensive, inelegant solution for large-scale operation.

Mechanical methods refer to operating an autonomous farming machine to autonomously place sugarcane billets into the pre-formed furrows within the field. Current mechanical methods, however, do not plant billets with the proper spacing and orientation within the furrows of the field. Further, current mechanical methods lack real-time feedback in adjusting and correcting billet planting issues. Overall, current mechanical methods do not provide real-time insights into the yield of these autonomous farming machines. This results in managers identifying issues only after germination, when it may be too late to correct those issues. Thus, there exists a current need for developing a system that allows for the efficient planting of billets for large-scale operations.

### SUMMARY

A method for predicting a yield of a sugarcane planting machine is disclosed. The disclosed method accesses a target planting ratio, which is a quantification of a target ratio of billets to soil in a furrow over a distance. The disclosed method accesses, in real-time, from a camera of the sugarcane planting machine, image data representing a furrow in the field, where the image data comprises, pixels representing billets and soil in the furrow. The disclosed method applies a machine-learned model to the accessed image data to classify the image data as billets or soil, and to calculate the current planting ratio, which is a quantification of a current ratio of billets to soil in the furrow over the distance. The disclosed method generates a visualization for a user interface, wherein the visualization comprises the classified image data captured by the camera of the sugarcane planting machine, a time series of the current planting ratio, and a comparison of the current planting ratio and the target planting ratio to display to the manager of the sugarcane planting machine.

### BRIEF DESCRIPTION OF THE DRAWINGS

FIG. 1A is an isometric view of a farming machine that performs farming actions of a treatment plan, according to one example embodiment.

FIG. 1B is a perspective view of a sugarcane planting machine, in accordance with at least one embodiment.

FIG. 1C is a side view of the sugarcane planting machine, in accordance with at least one embodiment.

FIG. 1D is a perspective view of a detection mechanism of the farming machine, in accordance with at least one embodiment.

FIG. 2 is a block diagram of a system environment for the farming machine, in accordance with at least one embodiment.

FIG. 3 illustrates a block diagram of the billet planting module, in accordance with at least one embodiment.

FIG. 4 is a view of a target area taken from a camera with crop material deposited on the surface of a field, in accordance with at least one embodiment.

FIG. 5 is an example user interface visualization presented to a manager of the sugarcane planting machine, in accordance with at least one embodiment.

FIG. 6 is an example set of shadings of user interface visualizations presented to a manager of the sugarcane planting machine, in accordance with at least one embodiment.

FIG. 7 is a flowchart for the billet planting module for predicting a yield of a sugarcane planting machine, in accordance with at least one embodiment.

FIG. 8 is a block diagram illustrating components of an example machine for reading and executing instructions from a machine-readable medium.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Sugarcane Planting

Agricultural managers (“managers”) are responsible for managing farming operations in one or more fields. Managers work to implement a farming objective within those fields and select from among a variety of farming actions to implement that farming objective. When planting sugarcane, managers must determine the best course of action to adjust, e.g., planting efficiency and crop yield. Managers can be farmers, agronomists, or automated systems designed to manage farming operations.

Sugarcane is primarily planted using vegetative planting methods, where sections of the stalk, known as billets, are planted to generate new plants. Billets are short segments of sugarcane stalks, containing multiple nodes from which new shoots and roots can emerge. Proper billet placement is important for controlling germination rates, and ultimately increasing crop yield. Proper billet placement manifests itself in two ways: controlling billet placement ratios (e.g., within a target range) and placing billets at an appropriate orientation and depth in a furrow. The billet-to-soil ratio informs billet placement, enabling best-practice planting coverage of the field. The orientation and placement of billets within the furrow are crucial to promote the uniform emergence of sugarcane buds.

Currently, two primary methods are used for sugarcane planting to properly place billets: manual (hand) planting and mechanical planting. Manual planting refers to managers individually placing sugarcane billets into pre-formed furrows within a field, enabling proper spacing and orientation for target germination. This process requires significant labor, as each billet must be carefully positioned to maximize sugarcane yield. While manual planting allows for precise control over billet placement, it is highly time-consuming and labor-intensive. Manual planting methods restrict the scalability of sugarcane farming due to their labor-intensive nature, high costs, and time-consuming process, making it impractical for large-scale operation.

Mechanical methods refer to operating mechanized farming machines to place sugarcane billets (either autonomously or semi-autonomously) into furrows within the field. Current mechanical methods, however, do not properly space and/or orient billets within the furrows of the field because they lack real-time feedback in adjusting and correcting billet planting issues. This deficiency leads to improper billet placement, which results in a lower yield and decreased crop value for a manger. As noted above, mechanical methods lack high-quality, real-time insights into orientation and spacing. This results in farmers identifying issues only after germination, when it may be too late to compensate for, or overcome, those issues.

To illustrate, traditional methods for interpreting sugarcane include, e.g., (i) post-planting field inspections conducted through drone surveys and/or (ii) manual assessments. Those inspections conducted by drones provide a snapshot of field conditions, as the captured images provide an over-head view of the field. The images are typically incapable of identifying factors that lead to improving billet placement and orientation. On the other hand, manual inspections include a manager to walk through the furrows of the field to physically assess sugarcane planting conditions. These inspections, though more detailed, are time-consuming and labor-intensive, making them inefficient for large-scale farming operations. In both scenarios, the manager is not provided with a real-time, data-driven analysis of field conditions during planting. Without this analysis, it is challenging for a manager to plant sugarcane in an efficient manner that results in a target yield for the field.

The system and methods described herein provide a visualization, in real-time, to help farmers adjust and optimize planting operations for a sugarcane planting device during planting. The proposed method predicts the yield of a sugarcane planting machine by analyzing real-time image data captured during planting. To do so, the machine accesses a target planting ratio, representing the ideal ratio of billets to soil over a given distance. As the sugarcane planting machine plants a set of billets, a camera captures image data of the furrow into which they were placed. The machine-learned model processes image data, to classify the accessed image data as either billets or soil. The machine-learned model calculates a current planting ratio based on the classified image data. The current planting ratio represents the current ratio of billets to soil over a given distance. The proposed method accesses a user interface visualization generated for presentation on the sugarcane planting machine's display, representing a comparison of the current and target planting ratios. Managers may monitor and modify the sugarcane planting machine in real-time, in response to the user interface visualization.

### II. Farming Machines

### Overview

A farming machine that implements operations for adjusting planting operations to increase its yield may have a variety of configurations, some of which are described in greater detail below.

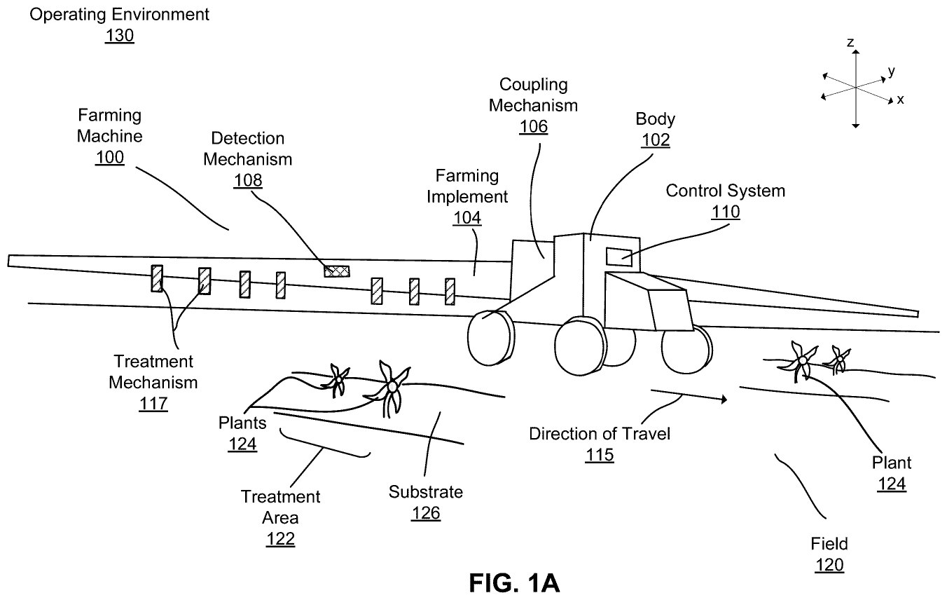

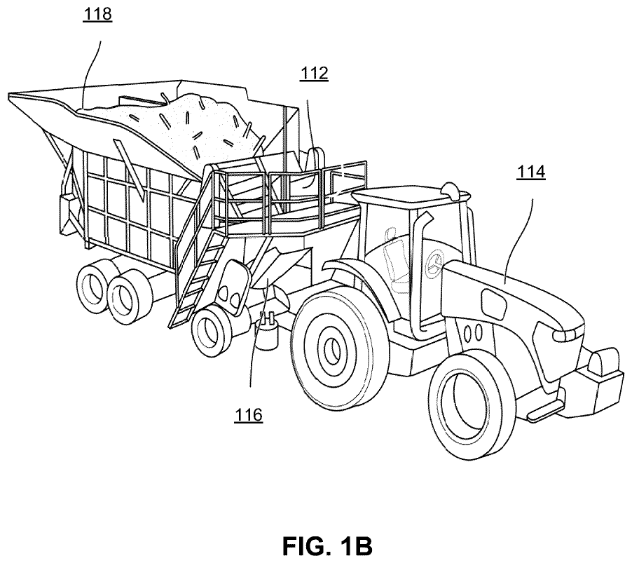

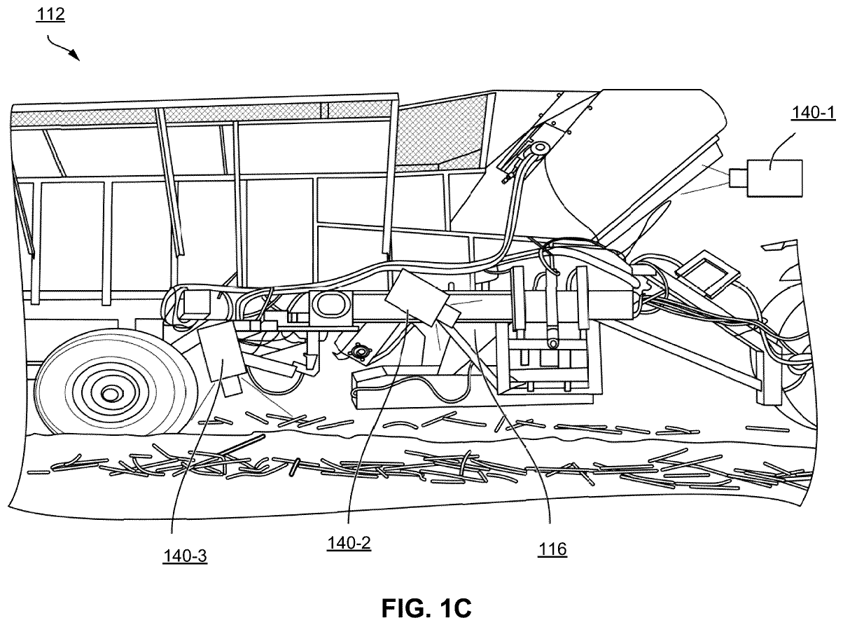

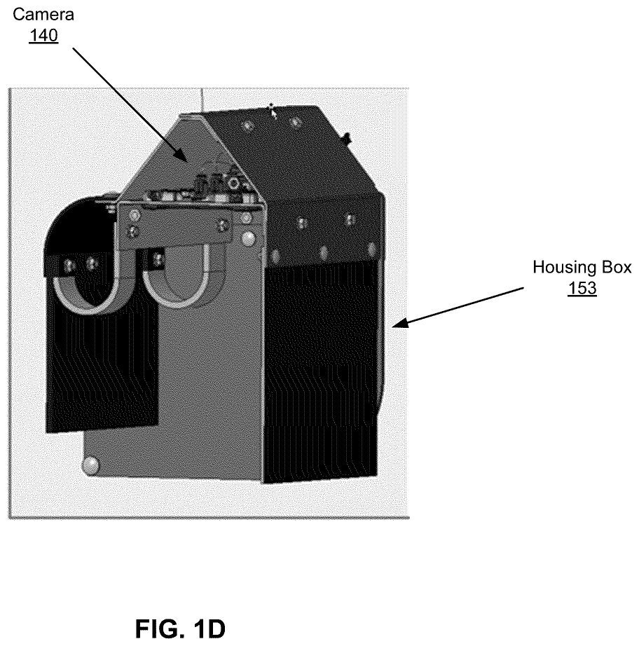

FIG. 1A is an isometric view of a farming machine 100 that performs farming actions of a treatment plan, according to one example embodiment. The farming machine 100 is configured to perform farming actions of a treatment plan in a field 120. As a non-limiting example, the farming machine 100 implements a farming action which applies a mechanical action to a treatment area 122 (e.g., tilling, digging a furrow, planting) within a geographic area of the field 120. In another example, the farming machine 100 is a sugarcane planting machine 112 that performs operations for planting sugarcane billets across the field 120. Further details of the sugarcane planting machine 112 are described in FIG. 1B-1C.

The operating environment 130 includes treatment areas 122. A treatment area 122 may contain one or more plants 124 (or plant matter such as seeds, billets, etc.) and/or the substrate 126. Farming actions are applied in treatment areas 122. For example, one farming action may be to till the substrate 126 in a treatment area 122 and another farming action may be to plant the plants 124 in a treatment area 122. The farming machine 100 may apply treatments directly to a single plant 124, directly to multiple plants 124, indirectly to one or more plants 124, to the environment associated with the plant 124 (e.g., the substrate 126, soil, atmosphere, or other suitable portion of the plant's environment adjacent to or connected by an environmental factors, such as wind), or otherwise.

The farming machine 100 operates in an operating environment 130 and includes a body 102, an implement 104, a coupling mechanism 106, a detection mechanism 108, and a control system 110. The described components and functions of the farming machine 100 are just examples, and a farming machine 100 can have different or additional components and functions other than those described below.

### Operating Environment

The farming machine 100 operates in an operating environment 130. The operating environment 130 is the environment surrounding the farming machine 100 while it performs farming actions of a treatment plan. The operating environment 130 may also include the farming machine 100 and its corresponding components. The operating environment 130 typically includes a field 120, and the farming machine 100 generally implements farming actions which applies a mechanical action to a treatment area 122 within a field 120. The field 120 is a geographic area where the farming machine 100 performs farming actions of a treatment plan. The field 120 may be an outdoor plant field but could also be an indoor location that houses plants such as, e.g., a greenhouse, a laboratory, a grow house, a set of containers, or any other suitable environment. In one embodiment, a field may include a set of pre-formed furrows. The pre-formed furrows are trenches in the soil, within the field 120, engineered to guide planting. The pre-formed furrows within the field 120 ensure that seeds or crop units are positioned in the rows uniformly or near uniformly.

A field 120 may include any number of field portions. A field portion is a subunit of a field 120. For example, a field portion may be a portion of the field 120 small enough to include a single plant 124, large enough to include many plants 124, or some other size. The farming machine 100 can execute different farming actions for different field portions. In one embodiment, the farming machine 100 plants sugarcane billets into a series of pre-formed furrows within the field 120. Moreover, a field 120 and a furrow are largely interchangeable in the context of the methods and systems described herein. That is, treatment plans and their corresponding farming actions may be applied to an entire field 120 or a single pre-formed furrow, depending on the circumstances at play.

The operating environment 130 may also include plants 124. As such, farming actions the farming machine 100 implements as part of a treatment plan may be applied to plants 124 in the field 120. The plants 124 can be crops but could also be weeds or any other suitable plant 124. Some example crops include cotton, lettuce, soybeans, rice, carrots, tomatoes, corn, broccoli, cabbage, potatoes, wheat, sugarcane, or any other suitable commercial crop. The weeds may be grasses, broadleaf weeds, thistles, or any other suitable determinantal weed. In various examples, the plant 124 may be a vascular plant 124, non-vascular plant 124, ligneous plant 124, herbaceous plant 124, or be any suitable type of plant 124.

More generally, plants 124 may include a stem that is arranged superior to (e.g., above) the substrate 126 and a root system joined to the stem that is located inferior to the plane of the substrate 126 (e.g., below ground). The stem may support any branches, leaves, and/or fruits. The plant 124 can have a single stem, leaf, or fruit, multiple stems, leaves, or fruits, or any number of stems, leaves or fruits. The root system may be a tap root system or fibrous root system, and the root system may support the plant 124 position and absorb nutrients and water from the substrate 126.

The operating environment 130 may also include a substrate 126. As such, farming actions the farming machine 100 implements as part of a treatment plan may be applied to the substrate 126. The substrate 126 may be soil but can alternatively be a sponge or any other suitable substrate 126. The substrate 126 may include plants 124 or may include organic matter causing a plant to form. Therefore, in an embodiment, the substrate 126 may include a seed or a billet that, when planted, causes the emergence of a plant 124. As such, the farming machine 100, as part of a treatment plan, may plant seeds or billets into pre-formed furrows within the field 120 which cause plants to grow in the field.

### Detection Mechanism(s)

The farming machine 100 may include one or more detection mechanisms 108. A detection mechanism 108 may obtain information describing the farming machine 100, the farming implement, or the environment 130 surrounding the farming machine 100. The detection mechanism 108 may use the obtained information to aid in determining and implementing farming actions. For example, the detection mechanism 108 may identify objects (e.g., plants 124, substrate 126, persons, obstacles, etc.) in the operating environment 130 of the farming machine 100 based on images of the operating environment 130. For instance, the farming machine 100 may execute one or more detection algorithms (e.g., classifiers based on neural networks, etc.) to identify various features in the environment 130. As another example, the farming machine 100 may perform farming actions based on the identified objects, such as planning the discharge and distribution of billets to control or influence the predicted sugarcane yield.

The detection mechanism 108 may include one or more sensors. For example, the detection mechanism 108 can include a multispectral camera, a stereo camera, a CCD camera, a single lens camera, a CMOS camera, hyperspectral imaging system, LIDAR system (light detection and ranging system), a depth sensor, dynamometer, IR camera, thermal camera, humidity sensor, light sensor, temperature sensor, or any other suitable sensor. The detection mechanism 108 may be a sensor that measures a state of the farming machine 100. For example, the detection mechanism 108 may be a speed sensor, a heat sensor, or some other sensor that can monitor the state of a component of the farming machine 100. The detection mechanism 108 may be a sensor that measures components during implementation of a farming action. For example, the detection mechanism 108 may be a flow rate monitor, a mechanical stress sensor etc. The detection mechanism may be a Global Positioning System (GPS) device. The detection mechanism 108 may include an array of sensors. For example, the detection mechanism 108 may include an array of cameras configured to capture an array of pictures representing the environment 130 surrounding the farming machine 100 and a corresponding array of GPS devices tracking the location of each camera as the farming machine 100 moves.

The detection mechanism 108 may be mounted on the body 102 or the implement 104 of the farming machine 100. For example, though the detection mechanism 108 is shown in FIG. 1A as mounted on the farming implement 104, the detection mechanism 108 may be mounted on the body 102 pointed back towards the implement 104 or downwards towards the substrate 126. The detection mechanism 108 may be mounted depending on the information the detection mechanism obtains. For example, to obtain information about the state of the farming machine 100, such as the heat of the farming machine 100, the detection mechanism 108 may be mounted on the body of the farming machine 100. As another example, to detect the shape of the implement 104, the detection mechanism 108 may be a camera mounted on the body of the farming machine 100. As an example, the detection mechanism 108 may be mounted on the body of the farming machine 100 to capture images within a view of the pre-formed furrows as the farming machine 100 traverses the field 120. Depending on where the detection mechanism 108 is mounted relative to the implement 104, one or the other may pass over a geographic area in the field 120 before the other. For example, the detection mechanism 108 may be positioned on the body 102 of the farming machine 100 such that it traverses over a geographic location before the implement 104 as the farming machine 100 moves through the field 120. In other examples, the detection mechanism 108 is positioned on the implement 104 such that the two traverse over a geographic location at substantially the same time as the farming machine 100 moves through the filed. The detection mechanism 108 may be statically mounted to the body 102 or implement 104, or may be removably or dynamically coupled to the body 102 or implement 104. In other examples, the detection mechanism 108 may be mounted to some other surface of the farming machine 100 or may be incorporated into another component of the farming machine 100.

### Farming Implement(s)

The farming machine 100 may include a farming implement 104. The farming implement 104 can implement farming actions in the operating environment 130 of a farming machine 100. As an example, the farming machine 100 may include a farming implement 104 that efficiently plants sugarcane billets or seeds within the operating environment 130. More generally, the farming machine 100 uses the farming implement 104 to apply a treatment to a treatment area 122, and the treatment area 122 may include anything within the operating environment 130 (e.g., a plant 124 or the substrate 126). In other words, the treatment area 122 may be any portion of the operating environment 130.

To illustrate performing a treatment to a treatment area 122 when performing a treatment plan, the farming machine 100 may identify some trigger that indicates a farming action is needed. The farming machine 100 may actuate the farming implement 104 to apply a farming action to the treatment area. In an example, the farming action applies a mechanical action to the treatment area. For instance, the farming machine may dig a furrow in the treatment area. The farming implement 104 may include one or more physical implements (e.g., planting chutes) configured to manipulate plants, or other mechanisms for performing farming actions.

Additionally, when executing a farming action, the effect of implementing the farming action with a farming implement 104 may include any of plant necrosis, plant growth stimulation, plant portion necrosis or removal, plant portion growth stimulation, or any other suitable effect. Moreover, the farming implement 104 can apply a treatment that dislodges a plant 124 from the substrate 126, severs a plant 124 or portion of a plant 124 (e.g., cutting), incinerates a plant 124 or portion of a plant 124, electrically stimulates a plant 124 or portion of a plant 124, fertilizes or promotes growth (e.g., with a growth hormone) of a plant 124, waters a plant 124, applies light or some other radiation to a plant 124, and/or injects one or more working fluids into the substrate 126 adjacent to a plant 124 (e.g., within a threshold distance from the plant). Additionally, the farming implement 104 can administer a farming action to plant a billet in the substrate 126 for stimulating plant growth Other farming actions are also possible.

The farming implement 104 may be attached to the farming machine 100 via the coupling mechanism 106. To provide some contextual examples, the farming implement 104 may be any of a plow, harrow, cultivator, seeder/planter, fertilizer spreader, sprayer, mower, baler, tillage equipment, wagon/trailer, spreader, rotary tiller, forage harvester, grain cart. Each of the implements are configured to enable the farming machine 100 to perform different farming actions, and may perform different farming actions themselves. The farming implement 104 may be modified to perform different or additional farming actions. For example, a sprayer may be modified to include an object identification system to identify plants to spray. As another example, a planter can be modified to include a billet identification system to identify sugarcane billets while planting. In some embodiments, the farming implement may be modified with the addition of third-party equipment. Each of the farming implements may have different form factors, and modifications to the farming implements introduce further variation in form factors. The farming machine 100 accounts for differences in form factors in different manners, as described hereinbelow.

The farming implement 104 may movable (e.g., translatable, rotatable, etc.) on the farming machine 100 or actuatable to align the farming implement 104 to a treatment area 122. In some configurations, the farming machine 100 may align the farming implement 104 or a component of the farming implement 104 with an identified object in the operating environment 130.

### Coupling Mechanism(s)

The coupling mechanism 106 functions to removably or statically couple various components of the farming machine 100. For example, the coupling mechanism 106 may be a hitch that couples the implement 104 to the body 102. The coupling mechanism may couple one or more implements 104 to the farming machine 100. The coupling mechanism may also communicatively couple various elements of the farming machine 100. For instance, the coupling mechanism may communicatively couple a detection mechanism on the farming implement 104 to a control system 110 on a farming machine 100.

### Control System(s)

The control system 110 controls operation of the various components and systems on the farming machine 100. For instance, the control system 110 can obtain information about the operating environment 130, process that information to identify a farming action, and implement the identified farming action with system components of the farming machine 100. The control system 110 can receive information from any component or system of the farming machine 100. For example, the control system 110 may receive sensor data from the detection mechanism 108.

The control system 110 can provide input to the components of the farming machine 100. For instance, the control system 110 may be configured to input and control operating parameters of the farming machine 100 (e.g., speed, direction). Similarly, the control system 110 may be configured to input and control operating parameters of the detection mechanism 108. Operating parameters of the detection mechanism 108 may include processing time, location and/or angle of the detection mechanism 108, image capture intervals, image capture settings, etc. Finally, the control system 110 may be configured to generate machine inputs for farming implement 104. That is, the control system 110 may translate a farming action of a treatment plan into machine instructions implementable by the farming implement 104.

The control system 110 can be operated by a user operating the farming machine 100, wholly or partially autonomously, operated by a user connected to the farming machine 100 by a network, or any combination of the above. For instance, the control system 110 may be operated by an agricultural manager sitting in a cabin of the farming machine 100, or the control system 110 may be operated by an agricultural manager connected to the control system 110 via a wireless network. In another example, the control system 110 may implement an array of control algorithms, machine vision algorithms, decision algorithms, etc. that allow the farming machine 100 to operate autonomously or partially autonomously.

The control system 110 may be implemented by a computer or a system of distributed computers. The computers may be connected in various network environments. For example, the control system 110 may be a series of computers implemented on the farming machine 100 and connected by a local area network. In another example, the control system 110 may be a series of computers implemented on the farming machine 100, in the cloud, a client device and connected by a wireless area network.

The control system 110 can apply one or more computer models to determine and implement farming actions in the field 120. For example, the control system 110 can apply a plant identification module to images acquired by the detection mechanism 108 to determine and implement farming actions. In some embodiments, the control system 110 includes a display that shows a series of visualizations to a manager of the farming machine 100. This display provides graphical representations—such as real-time data, performance metrics, and system statuses—that help the manager monitor and make informed decisions about operations.

In some configurations, the farming machine 100 may additionally include a communication apparatus, which functions to communicate (e.g., send and/or receive) data between the control system 110 and a set of remote devices. The communication apparatus can be a Wi-Fi communication system, a cellular communication system, a short-range communication system (e.g., Bluetooth, NFC, etc.), or any other suitable communication system.

### Other Machine Components

The farming machine 100 may include locomoting mechanisms. The locomoting mechanisms may include any number of wheels, continuous treads, articulating legs, or some other locomoting mechanism(s). For instance, the farming machine 100 may include a first set and a second set of coaxial wheels, or a first set and a second set of continuous treads. In the either example, the rotational axis of the first and second set of wheels/treads are approximately parallel. Further, each set is arranged along opposing sides of the farming machine 100. Typically, the locomoting mechanisms are attached to a drive mechanism that causes the locomoting mechanisms to translate the farming machine 100 through the operating environment 130. For instance, the farming machine 100 may include a drive train for rotating wheels or treads. In different configurations, the farming machine 100 may include any other suitable number or combination of locomoting mechanisms and drive mechanisms.

### II. Sugarcane Planting Machine

FIG. 1B is a perspective view of a sugarcane planting machine, in accordance with at least one embodiment. The illustrated sugarcane planting machine 112 is pulled by a tractor 114 during operation. The sugarcane planting machine 112 is operatively connected to the tractor 114 to pull the sugarcane planting machine 112 across a field during operation. While the illustrated sugarcane planting machine 112 is pulled by the tractor 114, it is understood that in other implementations the sugarcane planting machine 112 may be self-propelled. In other implementations, an autonomous machine including a propulsion system having a power mover, such as an engine, is considered. An entirely self-contained autonomous planting machine is also possible. In addition, the sugarcane planting machine 112 may be a remotely operated planting machine having a remotely located operator.

The sugarcane planting machine 112 includes a hopper 118, a metering device, and a planting chute 116. The hopper 118 is a container for storing bulk crop material such as, for example, sugarcane billets (discussed below). The hopper 118, in turn, is configured to feed the crop material to the metering device whereby the metering device delivers the crop material at a pre-determined rate to the planting chute 116. The planting chute 116 is configured to discharge and distribute the crop material output by the metering mechanism to a surface of a field in a pre-determined pattern or manner. For example, in some implementations, as the sugarcane planting machine 112 is pulled across a field, the sugarcane planting machine 112 opens a trench (or furrow) and the planting chute 116 deposits the crop material from the hopper 118 into the trench, and, in some cases, closes the trench. Although the example of FIG. 1B shows a single planting chute 116, in other implementations, the sugarcane planting machine 112 may include more than one planting chute 116. In still other implementations, the sugarcane planting machine 112 may include multiple independently controlled planting assemblies, with each assembly having an independently controlled metering mechanism and planting chute while being pulled at a common speed by a single tractor 114. While one planting chute 116 is shown, which is known as a single row unit, in other implementations, the sugarcane planting machine 112 includes more that one row unit.

FIG. 1C is a side view of the sugarcane planting machine, in accordance with at least one embodiment. FIG. 1C illustrates a side view of an example of the sugarcane planting machine 112 that is pulled by the tractor 114 during operation. In this example, the sugarcane planting machine 112 includes camera 140-1, camera 140-2, and camera 140-3. The camera(s) 140 each include a field of view configured to capture video data that includes identifying and tracking individual elements and attributes of crop material that is distributed during operation of the sugarcane planting machine 112 and is subsequently planted. In some embodiments, the cameras 140 are positioned so that all crop material distributed by the sugarcane planting machine 112 will pass through the field of view of at least one camera. In other embodiments, the cameras 140 may be positioned so that a known proportion (e.g., 25%, 50%, 75%) of the volume of crop material distributed by the sugarcane planting machine 112 will pass through the field of view of at least one camera.

For example, the camera 140-1 is the hopper 118 to the meter device and/or dispensed from the meter device to the planting chute disposed above the sugarcane planting machine 112 with a field of view that captures crop material fed from 116. In another example, the camera 140-2 is disposed below the sugarcane planting machine 112 with a field of view that captures crop material in a target region of the planting chute 116. In another example, the camera 140-3 is disposed below the sugarcane planting machine 112 with a field of view that captures crop material discharged from the planting chute 116 onto a surface of a field. In some embodiments, the camera(s) 140 are mounted above the planting chute 116. For example, in such embodiments the camera 140 is positioned centered across a width of the planting chute 116. As a result, of the centered position the camera(s) 140 eliminate or reduce bias with respect to uneven shape of the crop material. In some implementations, two or more instances of the camera(s) 140 can be mounted in a common housing to ensure relative placement.

While the illustrated sugarcane planting machine 112 includes three cameras 140-1, 140-2, 140-3 positioned as described above, in other embodiments more or fewer cameras 140 may be present. For example, multiple cameras monitoring the operation of the meter device to identify and record each billet, plant 124 substrate, that passes therethrough during operation. In still other embodiments, one or more cameras 140 may be present to identify and record each billet that slides down and is distributed by the planting chute 116. In still other embodiments the cameras 140 may be mounted remotely from the sugarcane planting machine 112 such as, but not limited to, on the tractor 114, on a separately driven truck or tractor (not shown), and/or be mounted to a separate trailer being pulled behind the sugarcane planting machine 112.

FIG. 1D is a perspective view of a detection mechanism 108 of the farming machine 100, in accordance with at least one embodiment. In an embodiment, detection mechanism 108 of the farming machine 100 includes a set of cameras 140 configured within a housing box 153. The set of cameras 140 may include a multispectral camera, a stereo camera, a CCD camera, a single lens camera, a CMOS camera, hyperspectral imaging system, LIDAR system (light detection and ranging system), a depth sensor, dynamometer, IR camera, thermal camera, humidity sensor, light sensor, temperature sensor, or any other suitable sensor. The housing box 153 is a protective housing box designed to enclose the camera 140. In one embodiment, the housing box 153 is constructed of durable materials such as aluminum, polycarbonate, or weather-resistant plastic. The housing box 153 includes mounting interfaces, openings for lenses and sensors to mount the set of cameras 140. The housing box 153 is designed to shield the camera 140 from environmental factors such as dust, moisture, or impact.

### Example System Environment

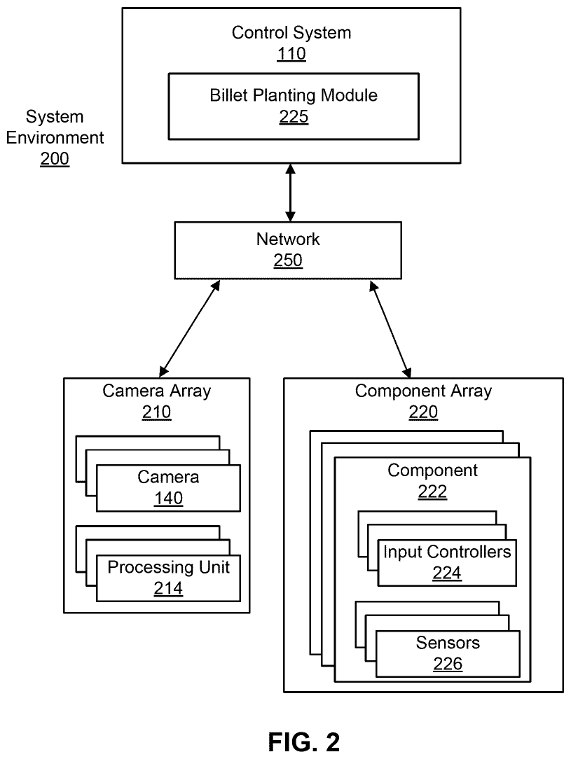

FIG. 2 is a block diagram of a system environment 200 for the farming machine 100 of FIGS. 1A-1D, in accordance with some embodiments. In this example system environment 200 of FIG. 2, a control system 110 is connected to a camera array 210 and component array 220 via a network 250. The camera array 210 includes one or more cameras 140. The cameras 140 may be a detection mechanism 108 as described in FIG. 1. Each camera 140 in the camera array 210 may be controlled by a corresponding processing unit 214 (e.g., a graphics processing unit). In some examples, more than one camera 140 may be controlled by a single processing unit 214. The array 210 captures image data of the scene around the farming machine 100. The captured image data may be sent to the control system 110 via the network 250 or may be stored or processed by other components of the farming machine.

The component array 220 includes one or more components 222. Components 222 are elements of the farming machine that can take farming actions (e.g., a treatment mechanism 117). As illustrated, each component has one or more input controllers 224 and one or more sensors 226, but a component may include only sensors or only input controllers. An input controller controls the function of the component. For example, an input controller may receive machine commands via the network and actuate the component in response. A sensor 226 generates measurements within the system environment. The measurements may be of the component, the farming machine, or the environment surrounding the farming machine. For example, a sensor 226 may measure a configuration or state of the component 222 (e.g., a setting, parameter, power load, etc.), or measure an area surrounding a farming machine (e.g., moisture, temperature, etc.).

In one or more embodiments, components 222 may include one or more planting components to plant or till an identified plant 124 or substrate 126 of a plant 124. As an example, components 222 may include one or more electromagnetic radiation sources to, e.g., emit a measured intensity of laser light, ultraviolet light, x-rays, or other electromagnetic radiation on an identified plant or portion of the plant (e.g., laser treatment action). As another example, components 222 may include one or more mechanical components (e.g., rotary hoe, plough, cutter, planter etc.) to, e.g., plant, cut, uproot, or dislodge an identified plant or portion of the plant (e.g., mechanical treatment actions). As another example, components 222 may include one or more pneumatic components to, e.g., blast a measured stream of pressurized air to cut an identified plant or portion of the plant (e.g., pneumatic treatment action). As another example, components 222 may include one or more vacuum or suction components to, e.g., generate suction to dislodge or uproot or suction an identified plant or plant portion (e.g., vacuum treatment action).

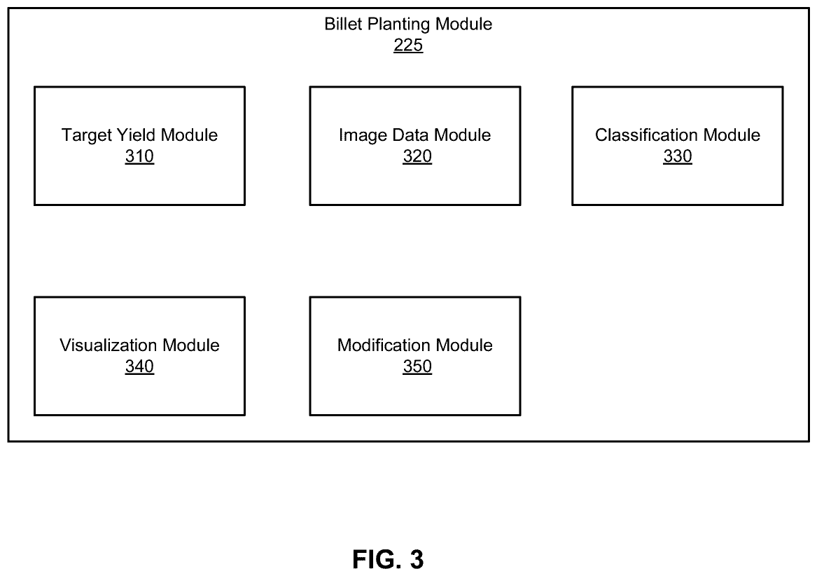

The control system 110 receives information from the camera array 210 and the component array 220, determines farming action plans (e.g., treatment actions, parameters of the actions), and performs one or more farming actions based on the farming action plans. For example, the control system 110 controls one or more of the components 222 to perform one or more planting actions based on a determined farming action plan for billet planting. In one embodiment, the control system 110 includes a billet planting module 225. Further details of the billet planting module 225 are described in FIGS. 3-7.

The network 250 connects nodes of the system environment 200 to allow microcontrollers and devices to communicate with each other. In some embodiments, the components are connected within the network as a Controller Area Network (CAN). In this case, within the network each element has an input and output connection, and the network 250 can translate information between the various elements. For example, the network 250 receives input information from the camera array 210 and the component array 220, processes the information, and transmits the information to the control system 110. The control system 110 generates a treatment plan including a treatment action based on the information and transmits instructions to implement the treatment plant to the appropriate component(s) 222 of the component array 220.

Additionally, the system environment 200 may be other types of network environments and include other networks, or a combination of network environments with several networks. For example, the system environment 200, can be a network such as the Internet, a LAN, a MAN, a WAN, a mobile wired or wireless network, a private network, a virtual private network, a direct communication line, and the like.

### III. Billet Planting Module

FIG. 3 illustrates a block diagram of the billet planting module 225, in accordance with some embodiments. The billet planting module 225 includes a target yield module 310, a image data module 320, a classification module 330, a visualization module 340, and a modification module 350, in accordance with one or more embodiments. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The target yield module 310 obtains a target planting ratio. A planting ratio is a metric quantifying a proportion of sugarcane billets to the soil in a planting furrow over a specified distance. For example, if a planting furrow extends over 100 meters and contains 50 sugarcane billets, the planting ratio would be 50 billets per 100 meters or 0.5 billets per meter. The target planting ratio is a metric quantifying the desired (or target) proportion of sugarcane billets to the soil in a planting furrow over a specified distance. As an example, the target planting ratio for the planting furrow extending over 100 meters is 65 sugarcane billets, the target planting ratio is 0.65 billets per meter. In one embodiment, the target yield module 310 obtains the target planting ratio by direct input from a farmer or by accessing systems equipped with predefined target planting ratios

The planting ratio may be used as a metric to quantify skips. A skip, during billet planting operations, is a gap where the sugarcane planting machine 112 omits or “skips” planting a sugarcane billet or seed along a furrow. By skipping a planting slot, the sugarcane planting machine 112 directly affects the planting ratio. Understanding the target planting ratio, gives farmers valuable insights into the effects of “skips”, improperly placed billets, and better assess areas where billets have been planted. Controlling the planting ratio, ultimately, allows managers to control the sugarcane yield of the farming machine 100.

A planting ratio can be used to determine other metrics. For instance, the planting ratio serves as a projection basis that allows the control system 110 to, e.g., project a mass of sugarcane per meter or the projected sugarcane yield per meter. In one embodiment, the projected sugarcane yield per meter may be determined based on historical sugarcane yield per meter data associated with similar planting ratios. As an example, the historical sugarcane yield per meter for a planting ratio of 0.5 billets per meter yields 20 kilograms of sugarcane per meter. Thus, a similar planting ratio of 0.5 billets per meter may yield 20 kilograms of sugarcane per meter, subject to environmental and management factors.

In another example, the planting ratio may serve as a projection basis that allows the control system 110 to estimate, e.g., the emergence rate. The emergence rates are the proportion of sugarcane billets that successfully sprout and develop into plants after planting. In one embodiment, the proportion of sugarcane billets that successfully sprout and develop into plants after planting may be determined based on historical emergence rate data associated with similar planting ratios. For example, consider a scenario where historical data indicates that a planting ratio of 0.5 sugarcane billets per meter yields an emergence rate of 90%. In a 100-meter furrow, this ratio results in 50 billets planted, and with a 90% emergence rate, about 45 billets successfully sprout.

In another example, the planting ratio may serve as a projection basis that allows the control system 110 to estimate, e.g., monetary value of an area of field. The monetary value may be determined based on historical monetary yield value data associated with similar planting ratios, yields, emergence rates, etc. For example, if historical monetary yield value data indicates that fields planted at a ratio of 0.5 billets per meter yield an average of $15 per meter of furrow, then a new field with 100 meters of furrow planted at this ratio would be projected to generate a monetary value of $1,500, subject to environmental and management factors.

These various estimations allow control system 110 to associate a planting ratio in the field with one or more agronomic factors important to a manager. For instance, the control system may associate a planting ratio with a monetary value stemming from that planting ratio, and provide, as discussed below, those predictions to the manager.

The image data module 320 retrieves (or accesses) an image of the furrow in the field. The image is captured by a detection mechanism 108, such as a set of cameras on the farming machine 100 (e.g., 140 configured within a housing box 153 as described in FIG. 1D). The retrieved images include pixels as image data, with the image data representing various elements within the furrow. For example, the image data may include billets (sugarcane stalk sections) and soil. The image data includes latent information —such as color, grouping patterns, and shapes—allowing image data module 320 to accurately classify the image data as either billets or soil. In one or more embodiments, the image data may also include elements representing obstructions within the field (and the corresponding latent information).

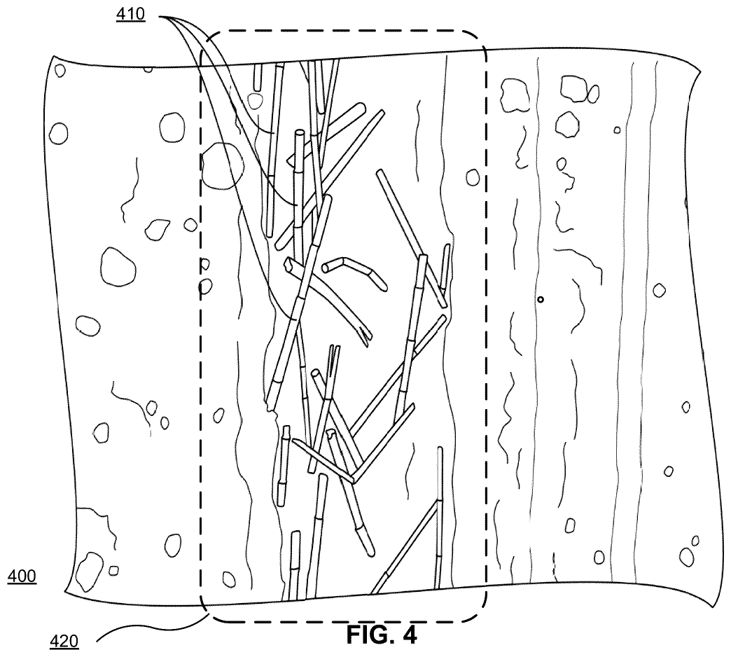

As an example, FIG. 4 is a view of the image captured by the detection system 108 of the farming machine. FIG. 4 is a view of a target area taken from a camera with billets deposited on the surface of a furrow. A target area 400 includes a view of a set of billets 410 deposited within a furrow 420. The dotted circle represents the furrow 420. The furrow is as an engineered depression within the soil of the field 120. The image data module 320 obtains image data of the target area 400, wherein the image data includes pixel data related to the set of billets 410 and the predefined furrows 420.

Returning to FIG. 3, the classification module 330 accesses the retrieved image of the furrow from the image data module 320. The classification module 330 applies a machine learning model trained to classify billets and soil in the retrieved image. As noted above, the classification module 330 identifies and classifies image data pixels corresponding to billets and soil. To do so, the machine learning model analyzes image data such as the color, texture, and shape (e.g., the latent information in the pixels), of the image data to accurately classify objects within the retrieved image. In some configurations, the machine learning model may classify obstructions identified within the image. Additionally, the classification module 330 may apply the machine learning module to identify a planting ratio based on the classified pixels (e.g., classified billets, soil, and obstructions)

In one or more embodiments, the classification module 330 applies the machine learning model to calculate the current planting ratio by performing either a pixel wise comparison between the identified pixels of billets to that of the soil, or a segmentation-based comparison between the number of classified billets to that of the soil.

Using the pixel-wise comparison, the classification module 330 analyzes every pixel in the accessed image to classify it as either representing a billet or soil. The classification module 330 determines the current planting ratio by counting the number of pixels identified as billets and compares this to the total number of pixels classified as soil. This approach provides high accuracy in distinguishing billets from the soil. In some cases, classification module 330 may extrapolate, e.g., a mass, area, etc., of billets or soil based on the number of identified pixels.

The segmentation-based approach focuses on identifying distinct objects based on groups of similarly classified pixels in the image, rather than evaluating individually classified pixels of the image. The classification module 330 applies the machine-learning model to the image and segments the retrieved image into clusters or regions representing soil or billets based on image data characteristics (e.g., color, shape, or texture). The segmentation-based approach calculates the current planting ratio by identifying the number of “distinct billet segments” and comparing its area to that of the identified “soil segments.” This approach may also quantify the area or mass of billets or soil such that the determined planting ratio may be, e.g., mass of billets per area, or number of billets per area.

The visualization module 340 generates a visualization. A visualization, as used herein, is a visual representation of one or more metrics determined (or measured) by the control system 110. The visualization may be, e.g., a depiction of the current planting ration (e.g., the planting ratio determined by classification module 330 as the farming machine plants billets) to a target planting ratio (e.g., a plant ratio accessed by the control system 110 and representing a best-practice planting ratio or range of planting ratios).

The visualization, more generally, is configured to present agronomic information that tailored to aid managers in making agronomic decisions based on the planting ratios. For example, the visualization may indicate whether a planting ratio is too high or too low, reflect a change in the planting ratio over time, depict a projection based on the planting ratio (e.g., emergence, yield, monetary value, etc.). The visualization may also depict various modifications that may be implemented to modify the planting ratio, some of which are described hereinbelow.

The visualization can present the agronomic information in various ways. For instance, the visualization may include graphs, images, labelled images, shaded images, annotated graphs, etc. Additionally, the information may be displayed and updated in real time, may provide temporal snapshots, or may provide an aggregation of information. As a specific example, the visualization may include a real-time image of the furrow that is labelled with the output of classification module 330 (e.g., labelled billets and substrate). The visualization may also include a time-series representation of the current planting ratio relative to a range of target planting ratios. The visualization may display one or more visual indicators (e.g., changing shading) based on the relative difference between the current planting ratio to the target planting ratio.

The visualization module 340 may generate and provide the visualization in a variety of ways. For example, the visualization module may generate and provide the visualization for display on a user interface on the farming machine, or may transmit the visualization to a control system used to manage the farming machine 100 (e.g., a smart phone). Whatever the case, visualization module 340 may adapt the visualization for display on the receiving device, or to the specifications of the manger.

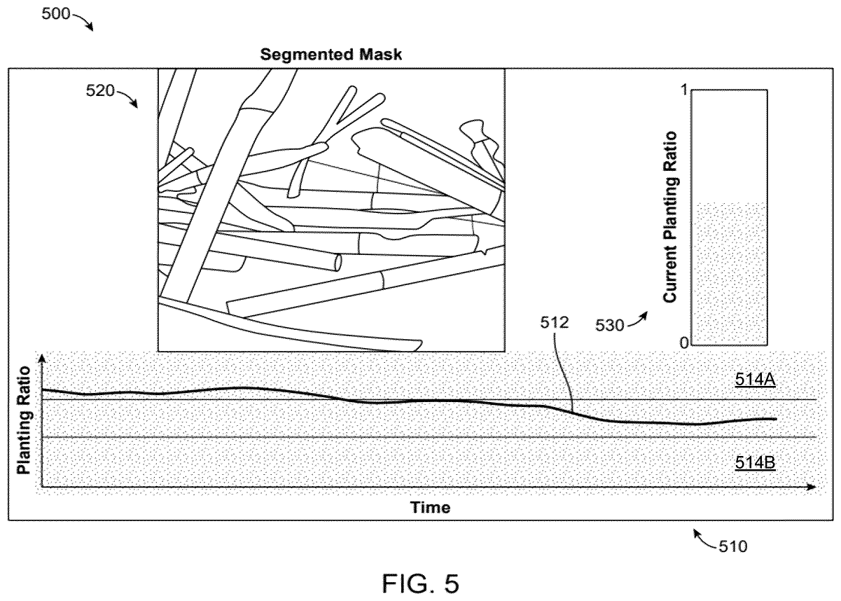

FIG. 5 is an example visualization presented, in real-time, to a manager of the sugarcane planting machine 112, in accordance with at least one or more embodiments. The visualization depicts a vertical bar graph displaying the current planting ratio, the captured images used to determine the current planting ratio, and a time series of the current planting ratio.

The lower portion of the visualization 500 illustrates a time-series 510. In the time-series, the x-axis represents the time (or distance) and the y-axis represents the current planting ratio. The line 512 represents illustrates the current planting ratio across the depicted period of time (or distance), capturing fluctuations in the planting consistency. The visualization also shows the target planting ratio. In this case the target planting ratio has an upper range 514A and a lower range 514B. When the current planting ratio (shown as line 512) approaches or passes the planting ratios with an upper range 514A and a lower range 514B, the visualization 500 may change (e.g., change color).

The upper left portion of the user interface visualization 500 includes a captured image 520 by the control system 110 of a target area taken depicting billets being deposited on the surface of a furrow. As described above, the classification module 330 identifies billets and soil within images, and the classification is depicted in the captured view of the captured image 520. The captured image 520 highlights the identified billets to allow for a user to easily identify areas of interest.

The upper right portion of the user interface visualization 500 illustrates a vertical bar graph displaying the current planting ratio 530. The vertical bar scale ranges from 0 to 1, with the fill of the bar graph indicating the real-time detected planting ratio. The current planting ratio is displayed in the fill of the bar graph from 0 to 1. As an example, the current planting ratio 530 is around 0.5 as the fill of the bar graph is about halfway from 0 to 1. This allows for the manager of the sugarcane planting machine 112 to easily identify the current planting ratio.

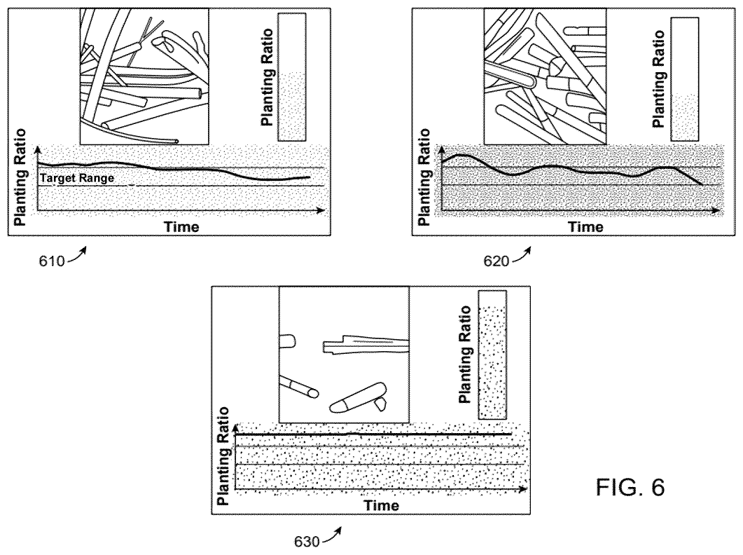

In FIG. 6, a first visualization 610 indicates that the current planting ratio is within a target threshold of the target planting ratio, where the current planting ratio is within an target threshold of the target planting ratio. A second visualization 620 indicates that the current planting ratio is within a second threshold of the target planting ratio. A third visualization 630 illustrates where the current planting ratio is not within a threshold of the target planting ratio. The different shadings in each visualization indicate relative differences between the target planting ratio and the current planting ratio.

Returning to FIG. 3, the billet planting module 225 includes a modification module 350. The modification module 350 identifies one or more modifications to farming actions to implement based on the current planting ratio. The modifications are, generally, various parameters of the sugarcane planting machine 112 that adjust the current planting ratio. The modifications are identified and selected based on the current planting ratio relative to the target planting ratio. For example, the modification module 350 may identify and select a modification that increases the current planting ration when the current planting ratio is below the threshold planting ratio (and vice versa when it is above the threshold).

Various modifications for controlling the current planting ratio are possible. As an example, the modification module 350 may cause the farming machine 100 to decrease the speed of sugarcane planting machine 112, adjust the orientation of the planter of the sugarcane planting machine 112, or adjust the conveyor belt speed of the planter. Other modifications are also possible.

In various configurations, the modification module 350 may provide suggested modifications to a manager and receive confirmation from the manager as a result. In this case, the farming machine 100 may implement the suggested modification responsive to the confirmation. In some cases, the farming machine may autonomously, or semi autonomously, implement the modifications to control the planting ratio to remain within the target planting ratio.

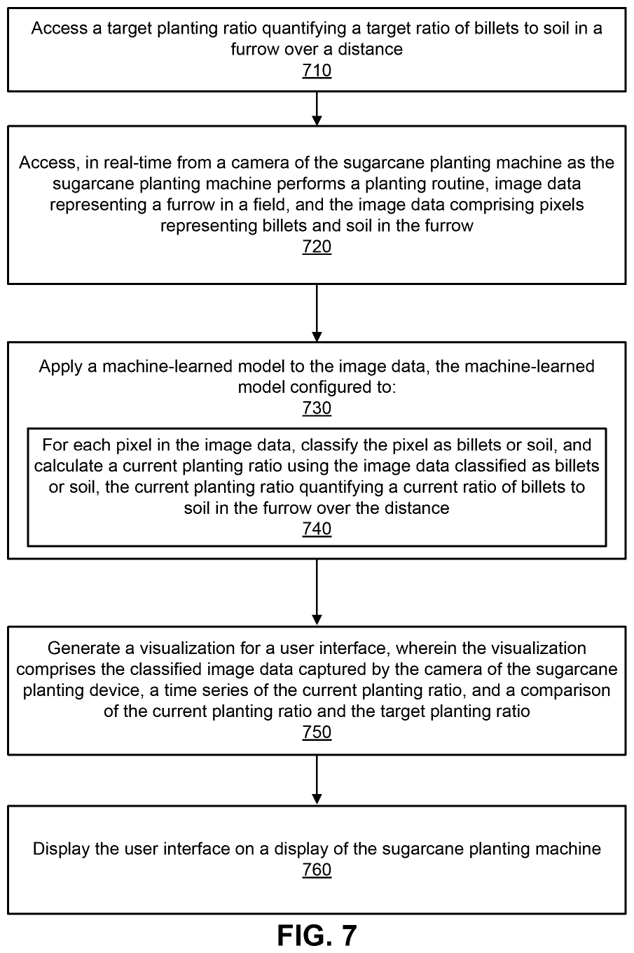

FIG. 7 is a flowchart for the billet planting module 225, in accordance with at least one or more embodiments. Alternative embodiments may include more, fewer, or different steps from those illustrated in FIG. 7 and the steps may be performed in a different order from that illustrated in FIG. 7.

The billet planting module 225 accesses a target planting ratio quantifying a target ratio of billets to soil in a furrow over a distance. The billet planting module 225 accesses 720, in real-time from a camera of the sugarcane planting machine as the sugarcane planting machine performs a planting routine, image data representing a furrow in a field, and the image data comprising pixels representing billets and soil in the furrow. The billet planting module 225 applies 730 a machine-learned model to the image data, the machine-learned model configured to: for each pixel in the image data, classify 740 the pixel as billets or soil, and calculate a current planting ratio using the image data classified as billets or soil, the current planting ratio quantifying a current ratio of billets to soil in the furrow over the distance. The billet planting module 225 generates 750 a visualization for a user interface, wherein the visualization comprises the classified image data captured by the camera of the sugarcane planting device, a time series of the current planting ratio, and a comparison of the current yield ratio and the target yield ratio. The billet planting module 225 displays 760 the user interface on a display of the sugarcane planting machine.

### IV. Computer System

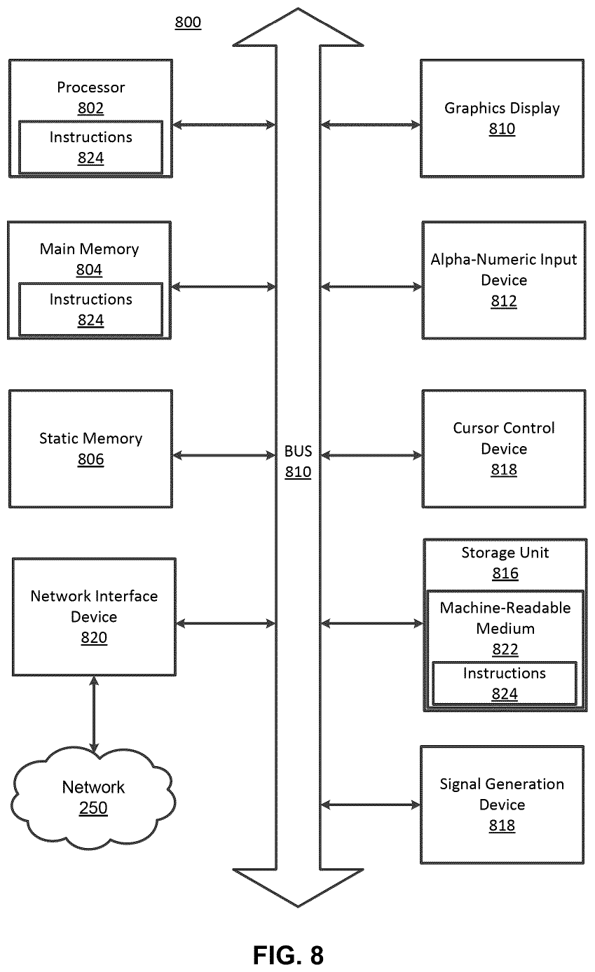

FIG. 8 is a block diagram illustrating components of an example machine for reading and executing instructions from a machine-readable medium. Specifically, FIG. 8 shows a diagrammatic representation of control system 110 in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804, and the storage unit 816 communicate via a bus 808.

In addition, the computer system 800 can include a static memory 806, a graphics display 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of the system 110 described in FIG. 3. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 250 via the network interface device 820.

### V. Additional Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. Furthermore, it has also proven convenient at times, to refer to arrangements of operations as modules, without loss of generality. The described operations and their associated modules may be embodied in software, firmware, hardware, or any combinations thereof.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method of predicting a yield of a sugarcane planting machine, the method comprising:
accessing a target planting ratio quantifying a target ratio of billets to soil in a furrow over a distance;
accessing, in real-time from a camera of the sugarcane planting machine as the sugarcane planting machine performs a planting routine in a field, image data representing the furrow in the field, and the image data comprising pixels representing billets and soil in the furrow;
applying a machine-learned model to the image data, the machine-learned model configured to:
for each pixel in the image data, classify the pixel as billets or soil, and
calculate a current planting ratio using the image data classified as billets or soil, the current planting ratio quantifying a current ratio of billets to soil in the furrow over the distance;
generating visualization for a user interface, wherein the visualization comprises the classified image data captured by the camera of the sugarcane planting machine, a time series of the current planting ratio, and a comparison of the current planting ratio and the target planting ratio; and
displaying the user interface on a display of the sugarcane planting machine.

2. The method of claim 1, further comprising:
determining an expected yield based on the calculated current planting ratio, wherein the expected yield is determined based on historical yield data associated with similar planting ratios.

3. The method of claim 1, further comprising:
determining an expected monetary value of sugarcane harvested from the field based on the current planting ratio, wherein the expected monetary value is determined based on historical monetary value data associated with similar planting ratios.

4. The method of claim 1, wherein calculating the current planting ratio by applying the machine-learned model comprises:
determining a ratio of pixels classified as billets to pixels classified as soil in the image data.

5. The method of claim 1, wherein calculating the current planting ratio by applying the machine-learned model comprises:
segmenting the image data to identify groups of pixels as billet segments and groups of pixels as soil segments; and
calculating the current planting ratio as a number of billet segments to a quantification of a number of soil segments.

6. The method of claim 1, further comprising:
determining a difference between the current planting ratio and the target planting ratio; and
responsive to determining the difference between the current planting ratio and the target planting ratio exceeds a threshold, determining a modification to adjust one or more planting parameters of the sugarcane planting machine.

7. The method of claim 6, further comprising:
modifying one or more planting parameters of the sugarcane planting machine; and
planting billets in the field using the modified parameters.

8. The method of claim 1, wherein the display is mounted on a tractor connected to the sugarcane planting machine.

9. The method of claim 1, wherein the camera of the sugarcane planting machine is mounted and oriented to capture image data of the furrow in the field.

10. An autonomous farming machine comprising:
one or more processors physically attached to the autonomous farming machine; and
a non-transitory computer readable storage medium storing computer program instructions that, when executed by the one or more processors, cause the one or more processors to:
access a target planting ratio quantifying a target ratio of billets to soil in a furrow over a distance;
access, in real-time from a camera of a sugarcane planting machine as the sugarcane planting machine performs a planting routine in a field, image data representing the furrow in the field, and the image data comprising pixels representing billets and soil in the furrow;
apply a machine-learned model to the image data, the machine-learned model configured to:
for each pixel in the image data, classify the pixel as billets or soil, and
calculate a current planting ratio using the image data classified as billets or soil, the current planting ratio quantifying a current ratio of billets to soil in the furrow over the distance;
generate a visualization for a user interface, wherein the visualization comprises the classified image data captured by the camera of the sugarcane planting machine, a time series of the current planting ratio, and a comparison of the current planting ratio and the target planting ratio; and
display the user interface on a display of the sugarcane planting machine.

11. The autonomous farming machine of claim 10, wherein the computer program comprises instructions that cause the one or more processors to:
determine an expected yield based on the calculated current planting ratio, wherein the expected yield is determined based on historical yield data associated with similar planting ratios.

12. The autonomous farming machine of claim 10, wherein the computer program comprises instructions that cause the one or more processors to:
determine an expected monetary value of sugarcane harvested from the field based on the current planting ratio, wherein the expected monetary value is determined based on historical monetary value data associated with similar planting ratios.

13. The autonomous farming machine of claim 10, wherein the computer program instructions for calculating the current planting ratio by applying the machine-learned model comprises instructions that cause the one or more processors to:
determine a ratio of pixels classified as billets to pixels classified as soil in the image data.

14. The autonomous farming machine of claim 10, wherein the computer program instructions for calculating the current planting ratio by applying the machine-learned model comprises instructions that cause the one or more processors to:
segment the image data to identify groups of pixels as billet segments and groups of pixels as soil segments; and
calculate the current planting ratio as a number of billet segments to a quantification of a number of soil segments.

15. A non-transitory computer readable storage medium storing computer program instructions that, when executed by one or more processors, cause the one or more processors to:
access a target planting ratio quantifying a target ratio of billets to soil in a furrow over a distance;
access, in real-time from a camera of a sugarcane planting machine as the sugarcane planting machine performs a planting routine in a field, image data representing the furrow in the field, and the image data comprising pixels representing billets and soil in the furrow;
apply a machine-learned model to the image data, the machine-learned model configured to:
for each pixel in the image data, classify the pixel as billets or soil, and
calculate a current planting ratio using the image data classified as billets or soil, the current planting ratio quantifying a current ratio of billets to soil in the furrow over the distance;
generate a visualization for a user interface, wherein the visualization comprises the classified image data captured by the camera of the sugarcane planting machine, a time series of the current planting ratio, and a comparison of the current planting ratio and the target planting ratio; and
display the user interface on a display of the sugarcane planting machine.

16. The non-transitory computer readable storage medium of claim 15, wherein the computer program comprises instructions that cause the one or more processors to:
determine an expected yield based on the calculated current planting ratio, wherein the expected yield is determined based on historical yield data associated with similar planting ratios.

17. The non-transitory computer readable storage medium of claim 15, wherein the computer program comprises instructions that cause the one or more processors to:
determine an expected monetary value of sugarcane harvested from the field based on the current planting ratio, wherein the expected monetary value is determined based on historical monetary value data associated with similar planting ratios.

18. The non-transitory computer readable storage medium of claim 15, wherein the computer program comprises instructions for calculating the current planting ratio by applying the machine-learned model comprise instructions that cause the one or more processors to:
determine a ratio of pixels classified as billets to pixels classified as soil in the image data.

19. The non-transitory computer readable storage medium of claim 15, wherein the computer program instructions for calculating the current planting ratio by applying the machine-learned model comprises instructions that cause the one or more processors to:
segment the image data to identify groups of pixels as billet segments and groups of pixels as soil segments; and
calculate the current planting ratio as a number of billet segments to a quantification of a number of soil segments.

20. The non-transitory computer readable storage medium of claim 15, wherein the computer program comprises instructions that cause the one or more processors to:
determine a difference between the current planting ratio and the target planting ratio; and
responsive to determining the difference between the current planting ratio and the target planting ratio exceeds a threshold, determine a modification to adjust one or more planting parameters of the sugarcane planting machine.
